(19) United States
(12) Patent Application Publication
(10) Pub. No.: US 2025/0162666 A1
(43) Pub. Date: May 22, 2025

(54) POSITIONING STRUCTURE

(71) Applicant: TOYOTA JIDOSHA KABUSHIKI KAISHA, Toyota-shi (JP)

(72) Inventor: Takeyuki YABUUCHI, Toyota-shi (JP)

(73) Assignee: TOYOTA JIDOSHA KABUSHIKI KAISHA, Toyota-shi (JP)

(21) Appl. No.: 18/794,206

(22) Filed: Aug. 5, 2024

(30) Foreign Application Priority Data
Nov. 21, 2023 (JP) 2023-197224

(51) Int. Cl. B62D 65/02

(52) U.S. Cl. CPC B62D 65/026

(57) ABSTRACT

The positioning structure for the cover member attached to the vehicle member may include a plurality of positioning pins provided in the vehicle member, and a plurality of positioning holes provided in the cover member into which the plurality of positioning pins is respectively inserted. Each of the plurality of positioning holes may be a long hole in which a long axis extends in a direction in which the cover member peels off when the cover member is removed from the vehicle member. The longitudinal axis of at least one of the plurality of slots may not be parallel to the longitudinal axis of the other slot.

### CROSS-REFERENCE TO RELATED APPLICATION

This application claims priority to Japanese Patent Application No. 2023-197224 filed on Nov. 21, 2023, incorporated herein by reference in its entirety.

### BACKGROUND

### 1. Technical Field

The technology disclosed herein relates to a positioning structure for a cover member to be attached to a vehicle member.

### 2. Description of Related Art

Japanese Unexamined Patent Application Publication No. 2011-202743 (JP 2011-202743 A) discloses a positioning structure for a vehicle member. The positioning structure according to JP 2011-202743 A includes a cylinder block, a timing chain cover, a knock pin provided on the cylinder block, a knock hole, and a leaf spring. The knock hole is provided in the timing chain cover, and has a reference surface against which the knock pin abuts. The leaf spring is provided in the knock hole, and presses the knock pin against the reference surface. The cylinder block and the timing chain cover are positioned by fitting the knock pin into the knock hole.

### SUMMARY

In the positioning structure according to JP 2011-202743 A, the clearance between the knock pin and the knock hole is narrow. When the timing chain cover is removed from the cylinder block in such a manner as to be peeled off, the timing chain cover may be caught by the knock pin. A large load is applied to the knock pin. The present specification provides a technique capable of suppressing a positioning pin interfering with a cover member when the cover member is removed from a vehicle member.

In a first aspect of the present technology, a positioning structure for a cover member to be attached to a vehicle member may include:
a plurality of positioning pins provided on the vehicle member; and
a plurality of positioning holes provided in the cover member, the positioning pins being respectively inserted into the positioning holes.
   The positioning holes may be elongated holes with a long axis extending in a direction in which the cover member is peeled off when the cover member is removed from the vehicle member.
   A long axis of at least one of the elongated holes may not be parallel to a long axis of the other elongated holes.

According to this configuration, when the cover member is removed from the vehicle member in such a manner as to be peeled off, the positioning pin smoothly comes out from the positioning hole, and thus it is possible to suppress the cover member being caught by the positioning pin. Therefore, it is possible to suppress the positioning pin interfering with the cover member when the cover member is removed from the vehicle member.

In a second aspect, in addition to the first aspect, a height of the positioning pins inserted into the positioning holes may be greater than a height of the positioning holes in a thickness direction of the cover member.

In a third aspect, in addition to the first or second aspect, the cover member may include a grip portion provided at a position overlapping the long axis of the elongated hole.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle member and a cover member according to an embodiment;

FIG. 2 is a top view of a cover member of an embodiment;

FIG. 3 is a cross-sectional view (1) of a positioning structure of an embodiment; and.

FIG. 4 is a cross-sectional view (2) of the positioning structure of the embodiment.

### DETAILED DESCRIPTION OF EMBODIMENTS

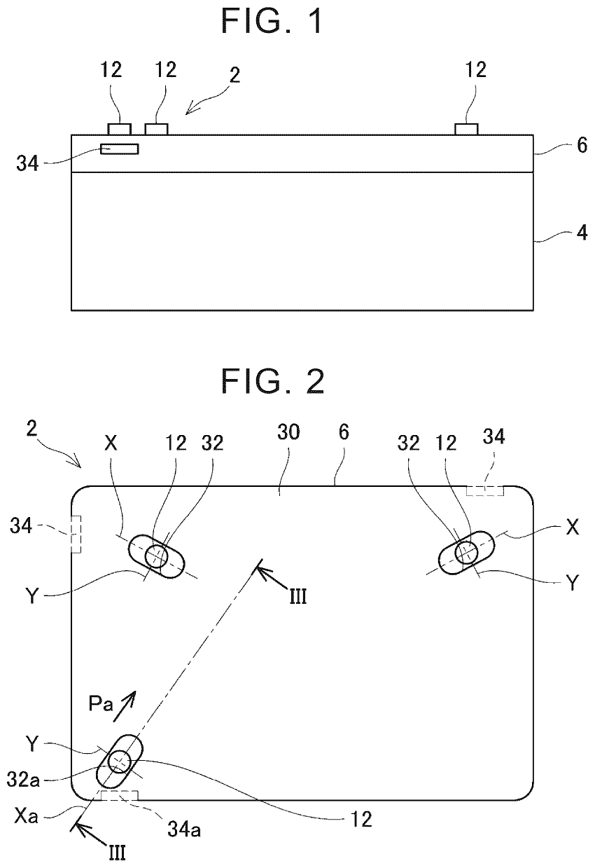

As shown in FIGS. 1 to 4, the positioning structure 2 of the embodiment is a structure for positioning the cover member 6 with respect to the vehicle member 4. The vehicle member 4 and the cover member 6 are mounted on, for example, an electrified vehicle (for example, a hybrid electric vehicle or a battery electric vehicle).

The vehicle member 4 is, for example, a case for accommodating an accommodated object (for example, a vehicle component such as a battery). The type of the vehicle member 4 is not particularly limited. The vehicle member 4 includes a main body 10 and a plurality of positioning pins 12 provided in the main body 10. The positioning pin 12 is provided at an upper end portion of the main body 10 and protrudes upward from an upper end portion of the main body 10. Further, the positioning pin 12 is provided, for example, in the vicinity of an outer peripheral edge portion of the main body 10. The plurality of positioning pins 12 are spaced apart from each other along an outer peripheral edge portion of the main body 10.

The cover member 6 is configured to be attachable to and detachable from the vehicle member 4. The cover member 6 covers an upper end portion of the main body 10 of the vehicle member 4 in a state of being attached to the vehicle member 4. The cover member 6 includes a main body 30 and a plurality of positioning holes 32 provided in the main body 30.

The positioning hole 32 penetrates the main body 30 in the thickness direction of the cover member 6. The positioning hole 32 is provided at a position corresponding to the positioning pin 12 of the vehicle member 4. The positioning hole 32 is provided, for example, in the vicinity of an outer peripheral edge portion of the main body 30. The plurality of positioning holes 32 are arranged at intervals along the outer peripheral edge portion of the main body 30. In a state where the cover member 6 is attached to the vehicle member 4, each of the plurality of positioning pins 12 of the vehicle member 4 is inserted into each of the plurality of positioning holes 32 of the cover member 6. The positioning structure 2 includes a plurality of positioning pins 12 provided in the vehicle member 4 and a plurality of positioning holes 32 provided in the cover member 6.

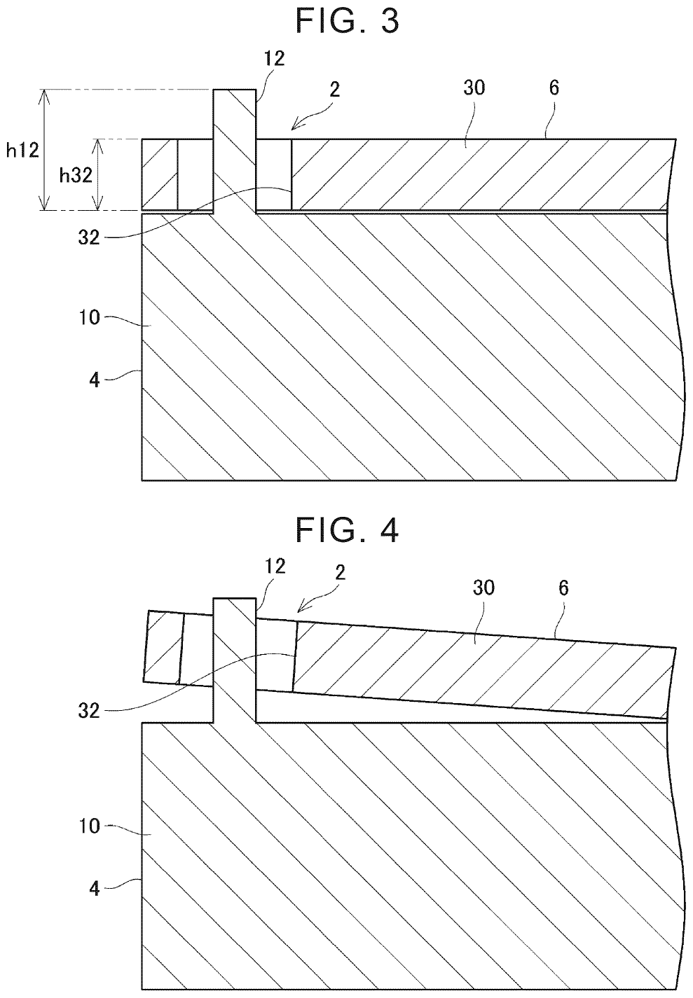

The height h12 of the positioning pin 12 inserted into the positioning hole 32 is higher than the height h32 of the positioning hole 32 in the thickness direction of the cover member 6 (see FIG. 3). In a state in which the cover member 6 is attached to the vehicle member 4, the upper end portion of the positioning pin 12 protrudes upward from the upper end portion of the positioning hole 32.

The positioning hole 32 of the cover member 6 is configured as a long hole having a long axis X and a short axis Y (see FIG. 2). The long hole (positioning hole 32) is a hole extending longer in the long axis X direction than in the short axis Y direction. The long hole (positioning hole 32) is configured such that the width in the long axis X direction is wider than the width in the short axis Y direction.

The positioning hole 32 of the cover member 6 is configured as an elongated hole in which the long axis X extends in a direction in which the cover member 6 peels off when the cover member 6 is removed from the vehicle member 4. For example, when attention is paid to an optional positioning hole 32a among the plurality of positioning holes 32 shown in FIG. 2, the long axis Xa of the positioning hole 32a (elongated hole) extends along the directional Pa that is peeled off when the cover member 6 is removed. In addition, the long-axis Xa of at least one long hole (for example, the positioning hole 32a) of the plurality of long holes (the positioning holes 32) of the cover member 6 is not parallel to the long axis X of the other long holes (the positioning holes 32). For example, the long axis Xa of the positioning hole 32a (long hole) extends so as to intersect the long axis X of the other positioning hole 32 closest to the positioning hole 32a.

The cover member 6 further includes a plurality of grip portions 34 provided at the outer peripheral edge portion of the main body 30. The plurality of grip portions 34 are arranged at intervals along the outer peripheral edge portion of the main body 30. For example, the cover member 6 is removed so as to be peeled off from the vehicle member 4 in a state in which one grip portion 34 is gripped by the user (see FIG. 4).

The plurality of grip portions 34 are provided in the vicinity of the plurality of positioning holes 32. Each grip portion 34 is provided at a position overlapping the long axis X of the positioning hole 32 (long hole) in the vicinity thereof. For example, when attention is paid to an arbitrary grip portion 34a among the plurality of grip portions 34 shown in FIG. 2, the grip portion 34a is provided at a position overlapping the long axis Xa of the positioning hole 32a (elongated hole) closest to the grip portion 34a.

According to the positioning structure 2 having the above-described configuration, the positioning pin 12 smoothly comes out of the positioning hole 32 when the cover member 6 is removed so as to be peeled off from the vehicle member 4. It is possible to suppress the cover member 6 being caught by the positioning pin 12. Therefore, it is possible to suppress the positioning pin 12 interfering with the cover member 6 when the cover member 6 is removed from the vehicle member 4. This configuration is particularly effective when the height h12 of the positioning pin 12 inserted into the positioning hole 32 is higher than the height h32 of the positioning hole 32 along the thickness of the cover member 6.

Further, in the configuration in which the grip portion 34 is provided at a position overlapping with the long axis X of the positioning hole 32 (elongated hole), when the user grips the grip portion 34 and removes the cover member 6 from the vehicle member 4, the cover member 6 is peeled off in a direction along the long axis X of the positioning hole 32 (elongated hole). The above configuration is particularly effective.

What is claimed is:

1. A positioning structure for a cover member to be attached to a vehicle member, comprising:
a plurality of positioning pins provided on the vehicle member; and
a plurality of positioning holes provided in the cover member, the positioning pins being respectively inserted into the positioning holes, wherein:
the positioning holes are elongated holes with a long axis extending in a direction in which the cover member is peeled off when the cover member is removed from the vehicle member; and
a long axis of at least one of the elongated holes is not parallel to a long axis of the other elongated holes.

2. The positioning structure according to claim 1, wherein a height of the positioning pins inserted into the positioning holes is greater than a height of the positioning holes in a thickness direction of the cover member.

3. The positioning structure according to claim 1, wherein the cover member includes a grip portion provided at a position overlapping the long axis of the elongated hole.
